(19) United States
(12) Patent Application Publication
(10) Pub. No.: US 2003/0106933 A1
(43) Pub. Date: Jun. 12, 2003

(54) Chip having parameter representing symbols perceivable by visually impaired persons

(76) Inventor: Marjorie Alexander, Philadelphia, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/315,497

(22) Filed: Dec. 10, 2002

Related U.S. Application Data
(60) Provisional application No. 60/337,894, filed on Dec. 10, 2001.

(51) Int. Cl. G06F 17/00

(52) U.S. Cl. 235/375

(57) ABSTRACT

A system for permitting a visually impaired person to engage in a game requiring a plurality of gaming chips representing a plurality of game parameter values wherein each gaming chip of the plurality of gaming chips represents a corresponding parameter value of the plurality of parameter values. A plurality of braille type symbols is disposed upon the plurality of gaming chips, wherein a braille type symbol of the plurality of braille type symbols disposed upon a selected gaming chip of the plurality of gaming chips indicates a parameter value of the plurality of parameter values corresponding to the selected gaming chip. The braille type symbol of the plurality of braille type symbols can include an elevated dot that is part of standard English braille.

### RELATED APPLICATIONS

This is a utility application based upon provisional application serial No. 60/337,894, filed on Dec. 10, 2001, entitled BRAILLE CHIP. Applicant hereby claims the benefit of the filing date of the '894 provisional application for this utility application and whose entire disclosure is incorporated by reference herein.

### SPECIFICATION

### Background of the Invention

### Description of Related Art

1. Field of the Invention

It is well known in the prior art to provide devices adapted to permit visually impaired persons to perform functions in a manner comparable to the manner that the functions are performed by sighted persons. It is widely recognized that bringing the ability to perform as many of the functions performed by sighted persons as possible to the visually impaired is a desirable public policy. In order to attain this goal it is necessary to enable the visually impaired to perceive objects, facts, locations, values, and other parameters which sighted persons routinely perceive using their vision when they perform the functions.

Unfortunately, many functions that the visually impaired could perform still remain unavailable to them for several reasons. For example, many functions remain unavailable because of the difficulty in solving the problems of making the information required to perform them conveniently available to visually impaired persons. Other functions remain unavailable because of the difficultly in recognizing that a function could be made available to the visually impaired, and the difficulty in finding a practical way to make the required information available in a manner effective to permit performance of the function.

One way to assist the visually impaired to perceive the things necessary to perform an expanded number of functions is by disposing markings that they can perceive upon objects involved in performing the functions. A number of prior art references teach assisting visually impaired persons to perform specific functions in this manner.

For example, it is known to provide cards and stickers having markings disposed upon them which could be used for making objects readable by visually impaired persons. U.S. Pat. No. 3,388,403 entitled “Employee Identification Card Recorder,” issued to Gieringer on Jun. 11, 1968 teaches a card upon which markings representing employee information are embossed. Japanese Patent Abstract No. 01185485, filed Jul. 18, 1989 teaches a magnetic card carved with braille characters and a device for performing the carving of the card. The card is adapted to permit visually impaired persons to conveniently fashion a small, durable representation of important information such as emergency telephone numbers which can be easily carried, for example, in their pockets. Another card having braille disposed thereupon is taught in Japanese Patent Abstract No. 08334571.

UK Patent Application GB 2,226,984 teaches an identity card having a visual image of a person, as well as embossed braille markings. The card is intended to serve as an identification card perceivable by visually impaired persons as well a by sighted persons. UK Patent Application GB 2,263,269 teaches molded braille characters on a self-adhesive material. The self-adhesive material is adhered to the surfaces of objects such as computer keyboards, products, games, etc. in order to assist the visually impaired in using them.

Another area where the prior art teaches using markings to assist visually impaired persons is the field of indicating the contents of containers, for example food containers. Japanese Patent Abstract No. 10104773 teaches a paper container having a braille display for indicating the contents of the container. Japanese Patent Abstract No. 2000377083 teaches a sealing cap for a container having a braille or other type of display for the same purpose.

Indicating locations and directions in a manner perceivable to the visually impaired in order to facilitate their ability to travel is another area where it is known to use markings or other means to expand their ability to perform functions routinely performed by sighted persons. U.S. Pat. No. 5,245,744, entitled “Method for Placing Braille Letters on Architectural Signs,” issued to Edgerton on Sep. 21, 1993, teaches drilling holes into the surface of a sign. The placement of the holes is selected to represent information and allow the visually impaired to touch the holes and thereby tactilely determine the location and direction information that is visually displayed on the sign.

U.S. Pat. No. 5,779,482, entitled “Indications for the Visually Handicapped Using Transparent Three-Dimensional Ink,” issued to Fukumoto on Jul. 14, 1998 teaches obtaining the same results as Edgerton by forming dots through a process of depositing ink on the sign in order to represent the location information that is visually displayed on the sign. Thus, the location information is rendered perceivable for the visually impaired when they touch the dots. Japanese Patent Abstract Nos. 2000067745 and 2000125617 teach tiles or blocks having markings perceivable by visually impaired persons disposed upon them. The markings represent directions and/or location information. The tiles or blocks are disposed in public locations where they can be easily reached in order to permit the visually impaired to touch the markings and perceive the directions.

One area where it is very important for the visually impaired to function is the area of performing financial transactions and communications. U.S. Pat. No. 4,761,542, issued to Kubo on Aug. 2, 1988, entitled “Automatic Money Receiving and Paying Method and Apparatus,” is one such teaching. U.S. Pat. No. 6,345,766, issued to Taskett on Feb. 12, 2002, and entitled “Methods and Apparatus for Providing a Prepaid, Remote Memory Customer Account for the Visually Impaired” is another such teaching. Taskett discloses a braille printer configured to print a wallet sized plastic prepaid telephone calling card.

The telephone calling card taught by Taskett has information fields printed in braille. The braille information fields can contain an identification of a host computer for use by the visually impaired person in completing prepaid telephone calls, an account code associated with a prepaid card, as well as any other information that may be useful in assisting the visually impaired person in making a prepaid telephone call.

U.S. Pat. No. 5,636,565, entitled “Embossing Method and Device for Braille Currency Encoding,” issued to Lawrance on Jun. 10, 1997, teaches providing currency wherein the value of the currency is rendered perceivable by visually impaired persons. A die used in the Lawrance method incorporates indentations corresponding to the braille markings of all of the currency denominations commonly in use. Visually impaired persons can use the die to mark a currency note by applying the corresponding die to the currency note, thereby embossing the note. Additionally, applying an adhesive backed label bearing the braille markings to a currency note is described.

A number of game and entertainment teachings for the visually impaired are also known in the prior art. For example U.S. Pat. No. 3,746,343, entitled “Magnetic Game Board Especially for Sightless Persons,” issued to Shapiro on Jul. 7, 1973 teaches a game wherein braille characters project from a surface of a grid representative of a playing surface. The projecting braille characters enable a visually impaired player to identify a game pattern reflected by the braille characters. This method is effective to permit the visually impaired player to locate the positions of game playing pieces. Game playing pieces having braille characters thereon, are magnetically held within the grid.

U.S. Pat. No. 5,522,728, entitled “Braille Slot Machine,” issued to Kaplan on Jun. 4, 1996 teaches a method for refreshing braille pins which form symbols displayed on a slot machine. The pins are adapted to move into predetermined positions corresponding to the symbols displayed by the slot machine as the slot machine is operated. Thus, by touching the refreshed pins a visually impaired person can determine the display on the slot machine as the slot machine is operated. This method allows the visually impaired person to enjoy playing slot machine.

U.S. Pat. No. 5,577,914, entitled “Device for Representing Braille on Information Signal Recording Medium and Disc Cartridge,” issued to Takahashi on Nov. 26, 1996 teaches a memory storage disc. The storage disc has a cartridge body and a shutter for opening and closing an aperture to permit access to the medium within the cartridge body. A braille portion indicates the type of disc-shaped recording medium that is provided in the cartridge to permit visually impaired persons to determine the type of medium.

U.S. Pat. No. 6,267,374, entitled “Braille Game Board,” issued to Bourbeau on Jul. 31, 2001 discloses a braille board and a plurality of braille indicating devices. The board is divided longitudinally and transversely to form cells and recesses. Indicating devices are provided having a plurality of pins each pin having a shaft to fit within one of the recesses. The pins have enlarged head portions located at one end. The game board device is suitable for use in hidden work puzzles, crossword puzzles, and the like.

Japanese Patent Abstract No. 09036830 discloses a card having tactilely recognizable braille. Japanese Patent Abstract No. 07107307 teaches a braille metal chip and braille metal plate wherein a resin is used in the manufacturing process. Japanese Patent Abstract No. 57043711 teaches a portable braille bill-making machine which enables visually impaired persons to make bills which are recognizable to them.

### BRIEF SUMMARY OF THE INVENTION

A system for permitting a visually impaired person to engage in a game requiring a plurality of gaming chips representing a plurality of game parameter values wherein each gaming chip of the plurality of gaming chips represents a corresponding parameter value of the plurality of parameter values. A plurality of braille type symbols is disposed upon the plurality of gaming chips, wherein a braille type symbol of the plurality of braille type symbols disposed upon a selected gaming chip of the plurality of gaming chips indicates a parameter value of the plurality of parameter values corresponding to the selected gaming chip. The braille type symbol of the plurality of braille type symbols can include an elevated dot that is part of standard English braille. The braille type symbol can also be a hole. The a parameter value of the plurality of parameter values can be a monetary value, a point value or an indication of a player move. Visually perceptible indicia are disposed upon a gaming chip of the plurality of gaming chips. The visually perceptible indicia can be an alphabetic letter, a numeric value, a colorvalue, or a symbol indicating a player move. The visually perceptible indicia can represent the same parameter value as the braille type symbol or a different parameter value than the braille type symbol.

The invention can be used in legal gambling or in commercially marketed games designed for residential use. The invention would permit visually impaired patrons to play casino games such as black jack, table poker, roulette, and other games used in gambling environments, as well as games designed for home use which call for the use of chips of any type. The gaming chips that are currently used in casino and home games do not provide a means for visually impaired players to distinguish between chips representing different monetary denominations, or other information relevant to the subject game.

The current chips differentiate only in color and other markings, and provide no basis for distinction other than by sight. As a result, blind or other visually impaired individuals are prevented from effectively participating in such games. The chip of the present invention would solve this problem by providing a means for visually impaired individuals to differentiate between the chips. A visually impaired individual could read any pertinent information such as monetary denomination or color by feeling the raised dots on the chip (which can conform to the system or reading and writing through touch commonly known as standard English Braille, as is used primarily by the visually impaired, but could also conform to another similar system or method of reading and/or writing). The chips can be constructed as follows:

A small, round or substantially round chip can be produced from clay, fiberglass, plastic, a composite material created from ceramic materials, paper and glue, and/or any other material, compound or substance which may be utilized in the construction of a chip.

The weight of each chip can be approximately 9 to 10 grams, but is not limited to this specified range.

The shape can be generally circular with an approximate diameter of 1 ½ inches, but is not limited to this specified measurement or this shape.

The thickness of the chip can be approximately ⅛ inches, but is not limited to this specified measurement.

The texture can be generally smooth on the face and bottom of the chip, but is not limited to this specification.

At least one side of the chip, but possibly both, includes raised dots representing information such as monetary denomination, casino name, and/or any other relevant information, such dots preferably in conformation with the system of standard English Braille, or any other similar system or method.

The indicia on the chips may include dollar amounts, names of casinos, and/or other pertinent information or designs in the case of gambling gaming chips including colors and codes, and any pertinent information in the case of home gaming chips including information and colors.

### BRIEF DESCRIPTION OF SEVERAL VIEWS OF THE DRAWINGS

The features of this invention will become readily appreciated as the same becomes better understood by reference to the following detailed description when considered in connection with the accompanying drawings wherein:

FIG. 1 shows an elevational front view of the parameter representing chip of the present invention.

FIG. 2 shows an elevational bottom view of the parameter representing chip of FIG. 1.

FIG. 3 shows an elevational cut away view of the parameter representing chip of FIG. 1.

### DETAILED DESCRIPTION OF THE INVENTION

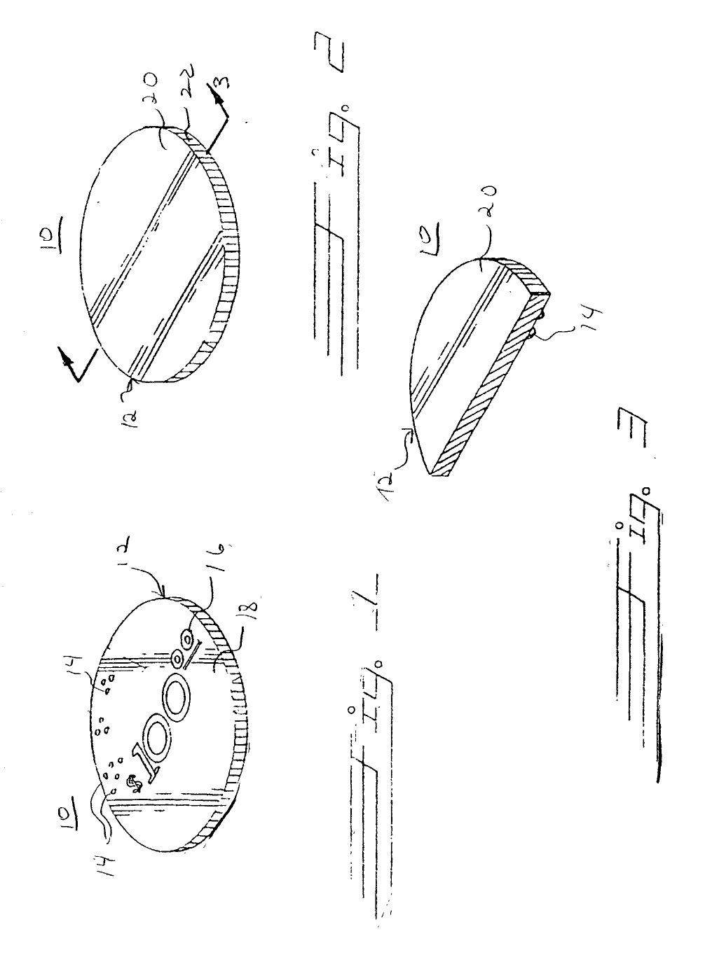

Referring to FIGS. 1-3, there is shown a plurality of views of the parameter representing chip 10 of the present invention. The parameter representing chip 10 is adapted for use by visually impaired persons in order to permit a visually impaired person to enjoy games that require players of the games to identify chips having differing parameter values.

For example, in many forms of gambling different types of chips can correspond to differing monetary values. A parameter representing chip 10 used for this purpose can be provided with visually perceptible alphabetical or numerical indicia 16, such as $10.00, $50.00 or $100.00 in order to indicate that the parameter representing chip 10 correspond to the monetary values $10.00, $50.00 or $100.00, respectively. Alternately, the visually perceptible indicia 16 can be different colors or symbols that represent different monetary values in games wherein the parameter representing chip 10 is used.

Additionally, parameters such as a number of points or different kinds of moves, or states, or status can be represented by the visually perceptible indicia 16. One skilled in the art will understand that the kinds of parameters and the kinds of visually perceptible indicia 16 that can be used to represent them in the field of gaming is limited only by the imagination of the people inventing games.

Therefore, the parameter representing chip 10 is adapted to provide a system and method for permitting visually impaired persons to enjoy games requiring any parameters to be communicated to a player using a chip. While the parameter representing chip 10 illustrated herein is round, it will be understood that the method and system of the present invention can be applied to chips of any shape or size.

The parameter representing chip 10 has a top surface 18, a bottom surface 20, and an edge surface 22. The visually perceptible indicia 16 can be disposed on the top surface 18, the bottom surface 20 and/or the edge surface 22 of the parameter representing chip 10. Visually perceptible indicia 16 can represent a monetary value, a number of points, a move that a player must make, or any other parameter that may be required by a game to a sighted person.

Braille-type symbols 14 are also disposed on the parameter representing chip 10. The braille-type symbols 14 can also be disposed on the top surface 18, the bottom surface 20, and/or the edge 22 of the parameter representing chip 10. If the parameter representing chip 10 is a multifaceted chip having more than two surfaces, the braille-type symbols 14, as well as the visually perceptible indicia 16, can be disposed on any of the surfaces.

The braille-type symbols 14 can be any type of symbol adapted to be perceptible by visually impaired persons. They can be the well known standard English braille symbols formed of a plurality of dots or points extending from or projecting from a surface of the parameter representing chip 10. Additionally, the braille-type symbols 14 can be formed of any other types of elevated dots including symbols formed of rounded dots, dots with edges or points, or any other type of elevation. Additionally, the braille-type symbols 14 can be holes, recesses or apertures in a surface 18, 20, 22 of the parameter representing chip 10, or passageways into or through the parameter representing chip 10.

The braille-type symbols 14 can be disposed on the parameter representing chip 10 by forming them using die, a mold, by embossing techniques, deposition of materials upon a surface, drilling, or any other method. The braille-type symbols 14 can represent the same parameter value as the visually perceptible indicia 16 on a parameter representing chip 10. However, the braille-type symbols 14 does not necessarily have to represent the same parameter value as the visually perceptible indicia 16, if the players of the game agree to differing pr parameter values for visually impaired persons and sighted persons.

While the invention has been described in detail and with reference to specific examples thereof, it will be apparent to one skilled in the art that various changes and modifications can be made therein without departing from the spirit and scope thereof.

What is claimed is:

1. A system for permitting a visually impaired person to engage in a game requiring a plurality of gaming chips representing a plurality of game parameter values, comprising:
a. each gaming chip of said plurality of gaming chips representing a corresponding parameter value of said plurality of parameter values; and
b. a plurality of braille type symbols disposed upon said plurality of gaming chips, wherein a braille type symbol of said plurality of braille type symbols disposed upon a selected gaming chip of said plurality of gaming chips indicates a parameter value of said plurality of parameter values corresponding to said selected gaming chip.

2. The system for permitting a visually impaired person to engage in a game of claim 1, wherein said braille type symbol of said plurality of braille type symbols comprises an elevated dot.

3. The system for permitting a visually impaired person to engage in a game of claim 2, wherein said elevated dot comprises standard English braille.

4. The system for permitting a visually impaired person to engage in a game of claim 1, wherein said braille type symbol of said plurality of braille type symbols comprises a hole.

5. The system for permitting a visually impaired person to engage in a game of claim 1, wherein a parameter value of said plurality of parameter values comprises a monetary value.

6. The system for permitting a visually impaired person to engage in a game of claim 1, wherein a parameter value of said plurality of parameter values comprises a point value.

7. The system for permitting a visually impaired person to engage in a game of claim 1, wherein a parameter value of said plurality of parameter values comprises an indication of a player move.

8. The system for permitting a visually impaired person to engage in a game of claim 1, further comprising visually perceptible indicia disposed upon a gaming chip of said plurality of gaming chips.

9. The system for permitting a visually impaired person to engage in a game of claim 8, wherein said visually perceptible indicia comprises an alphabetic letter.

10. The system for permitting a visually impaired person to engage in a game of claim 8, wherein said visually perceptible indicia comprises a numeric value.

11. The system for permitting a visually impaired person to engage in a game of claim 8, wherein said visually perceptible indicia comprises a color value.

12. The system for permitting a visually impaired person to engage in a game of claim 8, wherein said visually perceptible indicia comprises a symbol indicating a player move.

13. The system for permitting a visually impaired person to engage in a game of claim 1, wherein said visually perceptible indicia represents the same parameter value as said braille type symbol.

14. The system for permitting a visually impaired person to engage in a game of claim 1, wherein said visually perceptible indicia represents a different parameter value than said braille type symbol.

15. The system for permitting a visually impaired person to engage in a game of claim 1, wherein said gaming chip comprises a round gaming chip.
